(19) United States
(12) Patent Application Publication
(10) Pub. No.: US 2025/0076777 A1
(43) Pub. Date: Mar. 6, 2025

(54) TONER

(71) Applicant: SHARP KABUSHIKI KAISHA, Sakai City (JP)

(72) Inventor: YUYA KONDO, Sakai City (JP)

(21) Appl. No.: 18/806,523

(22) Filed: Aug. 15, 2024

(30) Foreign Application Priority Data
Sep. 6, 2023 (JP) 2023-144722

(51) Int. Cl. G03G 9/093; G03G 9/087

(52) U.S. Cl. CPC G03G 9/09364; G03G 9/08755; G03G 9/09335

(57) ABSTRACT

A toner with the following configuration includes a toner particle including a binder resin. The toner particle includes a styrene-based resin dispersed in a binder resin, a hydrocarbon-based wax dispersed in the styrene-based resin, and an ester wax as an encapsulation accelerator. The average dispersion diameter of the styrene-based resin is in a range from 200 nm to 900 nm, the average dispersion diameter of the hydrocarbon-based wax is less than the average dispersion diameter of the styrene-based resin and is in a range from 50 nm to 300 nm. The encapsulation ratio, which is the volume ratio of the hydrocarbon-based wax in the dispersed particles of the styrene-based resin, is in a range from 20% to 50%.

### TECHNICAL FIELD

The disclosure relates to toner.

### BACKGROUND ART

In recent years, a toner is required to have low-temperature fixability in order to realize energy saving in an image forming device such as a copying machine, a multi-function peripheral, a printer, or a facsimile apparatus using an electrophotographic system. In general, toner particles (toner cores) containing a resin as a main component and an external additive attached to surfaces of the toner particles are used as the toner.

A known method for enhancing the low-temperature fixability of toner includes adding a low-melting-point wax to toner particles, and a known method for imparting fluidity to toner includes adding a styrene-based resin to toner particles. Hereinafter, a toner having enhanced low-temperature fixability is also referred to as a low-temperature fixable toner.

For example, JP 2004-070076 discloses that in toner particles containing two types of resins, one type of resin is a copolymer obtained by copolymerizing monomers including a styrene-based monomer and an acrylic-based monomer, and a wax as a release agent is encapsulated in the resin.

### SUMMARY

### Technical Problem

However, in a toner in which a low-melting-point wax is added (internally added) into toner particles, if the dispersibility of the low-melting-point wax in the toner particle is poor, the low-melting-point wax may be unevenly distributed on the surface of the toner particle.

Low-melting-point wax exposed on the surface of the toner particles may cause problems such as a deterioration in heat-resistant storage capability of the toner and an occurrence of burn-in of toner on a developing roller.

The toner of the disclosure has been realized in light of such circumstances, and a main object of the disclosure is to provide a toner capable of suppressing burn-in on a developing roller while achieving both fixability and heat-resistant storage capability in a low-temperature fixable toner.

### Solution to Problem

In order to solve the problems described above, a toner according to the disclosure includes: a toner particle including a binder resin, wherein the toner particle includes a styrene-based resin dispersed in the binder resin, a hydrocarbon-based wax dispersed in the styrene-based resin, and an ester wax as an encapsulation accelerator, the styrene-based resin has an average dispersion diameter in a range from 200 nm to 900 nm, the hydrocarbon-based wax has an average dispersion diameter that is less than the average dispersion diameter of the styrene-based resin and is in a range from 50 nm to 300 nm, and an encapsulation ratio, which is a volume ratio of the hydrocarbon-based wax in dispersed particles of the styrene-based resin, is in a range from 20% to 50%.

In the toner described above, preferably when an SP value of the styrene-based resin is SP1, an SP value of the hydrocarbon-based wax is SP2, and an SP value of the ester wax is SP3, a relationship of SP2<SP3<SP1 is satisfied.

In the toner described above, preferably formulas (1) and (2) are satisfied:

$$SP 3 - SP 2 \leq 1. \qquad ( 1 )$$

$$SP 1 - SP 3 \leq 1. . \qquad ( 2 )$$

In the toner described above, preferably when a melting point of the hydrocarbon-based wax is T1 and a melting point of the ester wax is T2, a relationship of T1<T2 is satisfied.

In the toner described above, preferably a content of the ester wax in the toner particle is in a range from 0.2 mass % to 1 mass %.

The toner described above, preferably a content of the hydrocarbon-based wax in the toner particle is in a range from 2 times to 5 times a content of the ester wax.

In the toner described above, preferably a content of the styrene-based resin in the toner particle is in a range from 5 times to 10 times a content of the ester wax.

### Advantageous Effects of Disclosure

The toner of the disclosure realizes excellent effects such as achieving both fixability and heat-resistant storage capability in a low-temperature fixable toner and suppressing burn-in on a developing roller.

### BRIEF DESCRIPTION OF DRAWINGS

FIG. 1 is a schematic view for explaining a configuration of a toner according to an embodiment.

FIG. 2 is a schematic view for explaining an effect of bringing a styrene-based resin and a hydrocarbon-based wax together in a mechanism in which an ester wax functions as an encapsulation accelerator.

FIG. 3 is a schematic view for explaining an effect of enhancing the dispersibility of the hydrocarbon-based wax in the styrene-based resin in the mechanism in which the ester wax functions as an encapsulation accelerator.

### DESCRIPTION OF EMBODIMENTS

The toner of the disclosure will be described in detail below.

### 1. Toner Particles (Toner Cores)

The toner particles according to the present embodiment include an internal additive such as a colorant and a binder resin, and the internal additive is dispersed in the binder resin. An external additive is attached to the surface of the toner particle. Further, if necessary, an optional component may be included to a degree that does not impair the effects according to the disclosure. The average primary particle size of the toner particles may be appropriately selected depending on the intended purpose and is, for example, in a range from 4.5 μm to 8 μm.

The method for producing the toner particles is not particularly limited. For example, the toner particles can be produced by a pulverization method. Producing the toner particles via a pulverization method may include, for example, a mixing step of dry-mixing materials containing an internal additive such as a colorant and a binder resin with a mixer, a melt-kneading step of melt-kneading the obtained mixture with a kneader, a pulverizing step of pulverizing a solidified product obtained by cooling and solidifying the obtained melt-kneaded product with a pulverizer to obtain a finely pulverized product, and a classifying step of adjusting the particle size of the obtained finely pulverized product with a classifier or the like as necessary.

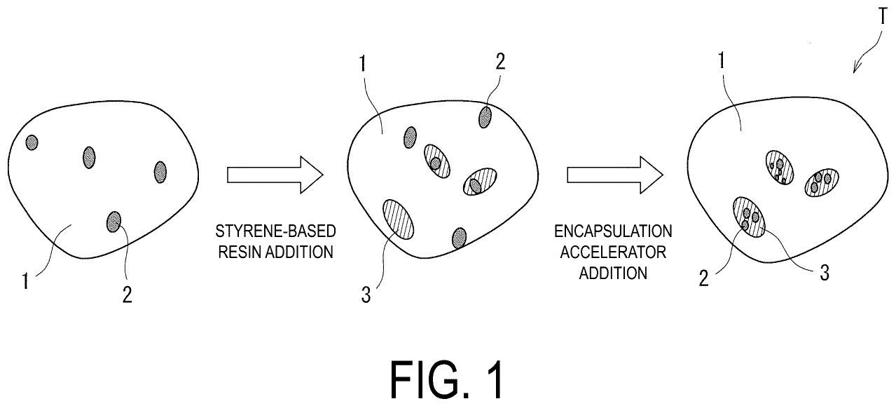

FIG. 1 is a schematic diagram for explaining the configuration of a toner according to an embodiment of the disclosure, and a toner particle T illustrated on the right side of FIG. 1 represents the configuration of the toner particle according to the present embodiment. As illustrated in the center of FIG. 1, when only the styrene-based resin is added to the toner particle containing a hydrocarbon-based wax as the release agent as illustrated on the left side of FIG. 1, a part of the hydrocarbon-based wax is encapsulated in the styrene-based resin, but a large amount of the hydrocarbon-based wax is not encapsulated.

On the other hand, as in the toner particle T illustrated on the right side of FIG. 1, the toner particles according to the present embodiment contain the styrene-based resin dispersed in the binder resin, the hydrocarbon-based wax dispersed in the styrene-based resin, and the ester wax included as an encapsulation accelerator. Since the toner particles according to the present embodiment contain the ester wax as the encapsulation accelerator, a larger amount of the hydrocarbon-based wax is encapsulated in the dispersed particles of the styrene-based resin and the hydrocarbon-based wax is present in a more dispersed state compared to the state illustrated in the center of FIG. 1.

By encapsulating the hydrocarbon-based wax in the styrene-based resin, the hydrocarbon-based wax having a low melting point is in a state of being encapsulated in the styrene-based resin in a temperature range used during storage of the toner, and thus the heat-resistant storage capability of the toner can be enhanced. In addition, when the temperature reaches the fixable temperature range (non-offset range) of the toner, both the styrene-based resin and the hydrocarbon-based wax are melted. Thus, there is also an effect that the encapsulation is less likely to inhibit the fixability. Furthermore, since the hydrocarbon-based wax (low-melting-point wax) is exposed on the surface of the toner particle and is less likely to be present due to encapsulation, it is possible to suppress the burn-in of the toner on the developing roller.

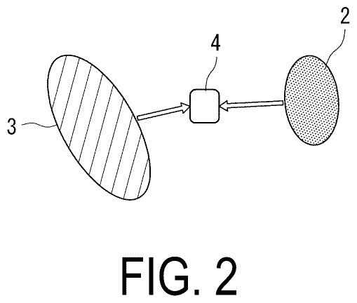

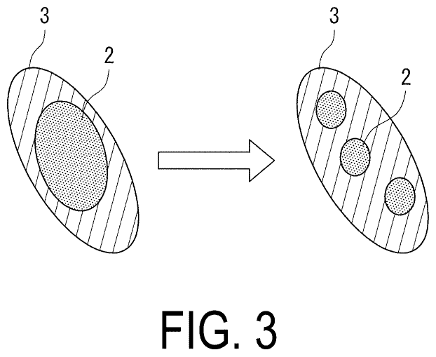

FIG. 2 is a schematic view for explaining an effect of bringing a styrene-based resin and a hydrocarbon-based wax together in a mechanism in which an ester wax functions as an encapsulation accelerator. As illustrated in FIG. 2, since the ester wax having a low melting point is easily compatible with the styrene-based resin, the styrene-based resin and the hydrocarbon-based wax are attracted to each other. Thus, the ester wax functions as an encapsulation accelerator. FIG. 3 is a schematic view for explaining an effect of enhancing the dispersibility of the hydrocarbon-based wax in the styrene-based resin in the mechanism in which the ester wax functions as an encapsulation accelerator. As illustrated in FIG. 3, since the ester wax is also easily compatible with the hydrocarbon-based wax, the ester wax promotes encapsulation of the hydrocarbon-based wax in the dispersed particles of the styrene-based resin with a small dispersion diameter.

By the above-described mechanism, in the toner according to the present embodiment, the particle size (dispersion diameter) of the dispersed particles of the styrene-based resin and the dispersion diameter of the hydrocarbon-based wax (low-melting-point wax) encapsulated in the dispersed particles of the styrene-based resin are controlled, and thus it is possible to suppress burn-in on the developing roller while achieving both fixability and heat-resistant storage capability in a low-temperature fixable toner.

Specifically, in the toner according to the present embodiment, the average dispersion diameter of the styrene-based resin is in a range from 200 nm to 900 nm, the average dispersion diameter of the hydrocarbon-based wax is less than the average dispersion diameter of the styrene-based resin and is in a range from 50 nm to 300 nm, and the encapsulation ratio, which is the volume ratio of the hydrocarbon-based wax in the dispersed particles of the styrene-based resin, is in a range from 20% to 50%. As described above, the hydrocarbon-based wax is encapsulated in the styrene-based resin, and the average dispersion diameters of the styrene-based resin and the hydrocarbon-based wax are controlled. Thus, it is possible to suppress burn-in on the developing roller while achieving both fixability and heat-resistant storage capability in a low-temperature fixable toner.

In the toner particles according to the present embodiment, the average dispersion diameter of the styrene-based resin dispersed in the binder resin is in a range from 200 nm to 900 nm, preferably from 400 nm to 800 nm, and more preferably from 500 nm to 700 nm. When the average dispersion diameter of the styrene-based resin is equal to or greater than the lower limit, it is possible to further enhance the heat-resistant storage capability of the toner and to further suppress the burn-in of the toner on the developing roller. When the average dispersion diameter of the styrene-based resin is equal to or less than the upper limit, the fixability of the toner can be further enhanced.

In the toner particles according to the present embodiment, the average dispersion diameter of the hydrocarbon-based wax dispersed in the styrene-based resin is in a range from 50 nm to 300 nm, preferably from 70 nm to 200 nm, and more preferably from 80 nm to 150 nm. When the average dispersion diameter of the hydrocarbon-based wax is equal to or greater than the lower limit, the fixability of the toner can be further enhanced. When the average dispersion diameter of the hydrocarbon-based wax is equal to or less than the upper limit, it is possible to further enhance the heat-resistant storage capability of the toner and to further suppress the burn-in of the toner on the developing roller.

In the toner particles according to the present embodiment, the encapsulation ratio, which is the volume ratio of the hydrocarbon-based wax in the dispersed particles of the styrene-based resin, is in a range from 20% to 50%, and more preferably from 25% to 40%. When the encapsulation ratio is equal to or greater than the lower limit, it is possible to further enhance the heat-resistant storage capability of the toner and to further suppress the burn-in of the toner on the developing roller. When the encapsulation ratio is equal to or less than the upper limit, the fixability of the toner can be further enhanced.

In the toner particles according to the present embodiment, when the SP value of the styrene-based resin is SP1, the SP value of the hydrocarbon-based wax is SP2, and the SP value of the ester wax is SP3, the relationship of SP2<SP3<SP1 is preferably satisfied. Accordingly, the hydrocarbon-based wax is easily encapsulated in the styrene-based resin, and it is possible to further enhance the heat-resistant storage capability of the toner and to further suppress the burn-in of the toner on the developing roller.

It is preferable that the toner particles according to the present embodiment further satisfy the relationships of Formulas (1) and (2) below. Regarding Formula (1), SP3−SP2 is more preferably 0.9 or less, and regarding Formula (2), SP1−SP3 is more preferably 0.8 or less. Accordingly, these materials are easily compatible with each other, and thus it is possible to further enhance the heat-resistant storage capability of the toner and to further suppress the burn-in of the toner on the developing roller.

$$SP 3 - SP 2 \leq 1. \qquad ( 1 )$$

$$SP 1 - SP 3 \leq 1. . \qquad ( 2 )$$

In the toner particles according to the present embodiment, when the melting point of the hydrocarbon-based wax is T1 and the melting point of the ester wax is T2, the relationship T1<T2 is preferably satisfied, and the T2 is more preferably higher than the T1 by 5° C. or more. Accordingly, the dispersibility of the hydrocarbon-based wax can be enhanced, and it is possible to further enhance the heat-resistant storage capability of the toner and to further suppress the burn-in of the toner on the developing roller.

Each material constituting the toner according to the present embodiment will be described below.

### Binder Resin

The binder resin contained in the toner particles according to the present embodiment is not particularly limited, but a polyester-based resin can be suitably used.

The polyester-based resin used for the binder resin is usually produced by subjecting one or more selected from the group consisting of dihydric alcohol components and trihydric or higher polyhydric alcohol components and one or more selected from the group consisting of divalent carboxylic acids and trivalent or higher polyvalent carboxylic acids to a polycondensation reaction through an esterification reaction or a transesterification reaction by a known method.

The conditions in the condensation polymerization reaction are to be appropriately set according to the reactivity of the monomer components, and the reaction is to be terminated when the polymer has suitable physical properties. For example, the reaction temperature is approximately from 170° C. to 250° C., and the reaction pressure is approximately from 5 mm Hg to normal pressure.

Examples of the dihydric alcohol component include alkylene oxide adducts of bisphenol A, such as poly(oxypropylene)(2.2)-2,2-bis(4-hydroxyphenyl)propane, poly(oxypropylene)(3.3)-2,2-bis(4-hydroxyphenyl)propane, poly(oxypropylene)(2.0)-2,2-bis(4-hydroxyphenyl)propane, poly(oxypropylene)(2.0)-poly(oxyethylene)(2.0)-2,2-bis(4-hydroxyphenyl)propane, and poly(oxypropylene)(6)-2,2-bis(4-hydroxyphenyl)propane; diols, such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenol A; propylene adducts of bisphenol A; ethylene adducts of bisphenol A; and hydrogenated bisphenol A.

Examples of the trihydric or higher polyhydric alcohol component include sorbitol, 1,2,3,6-hexanetetrol, 1,4-sorbitan, pentaerythritol, dipentaerythritol, tripentaerythritol, sucrose (cane sugar), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

In the toner according to the present embodiment, one of the dihydric alcohol components and trihydric or higher polyhydric alcohol components may be used individually, or two or more in combination.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, and acid anhydrides and lower alkyl esters of these.

Examples of the trivalent or higher polycarboxylic acid include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, and acid anhydrides and lower alkyl esters of these.

In the toner according to the present embodiment, one of the divalent carboxylic acids and trivalent or higher polyvalent carboxylic acids may be used individually, or two or more in combination.

The weight average molecular weight of the polyester-based resin is preferably in a range from 3000 to 50000. When the weight average molecular weight is less than the lower limit, the releasing property on the high temperature side of the fixable temperature range may be deteriorated. On the other hand, when the weight average molecular weight exceeds the upper limit, low-temperature fixability may be deteriorated.

The polyester-based resin preferably has an acid value in a range from 5 mgKOH/g to 30 mgKOH/g. When the acid value is less than the lower limit, the charging property of the polyester-based resin decreases and the charge control agent becomes difficult to disperse in the polyester-based resin, which may adversely affect the charge rising property and the charge stability during continuous printing. On the other hand, when the acid value exceeds the upper limit, the hygroscopicity may increase and the charging property may become unstable. Styrene-based Resin

The toner particles according to the present embodiment contain a styrene-based resin. The styrene-based resin is dispersed in the binder resin and is present as dispersed particles. Fluidity can be imparted to the toner by adding (internally adding) the styrene-based resin to the toner particles.

Examples of the styrene-based resin include homopolymers of styrene-based monomers such as styrene, α-methylstyrene, vinyltoluene, ethylstyrene, isopropylstyrene, and dimethylstyrene; copolymers thereof; and copolymers of styrene-based monomers and vinyl monomers copolymerizable with styrene-based monomers. Examples of the vinyl monomer include alkyl (meth) acrylates such as methyl (meth) acrylate, ethyl (meth) acrylate, and butyl (meth) acrylate; monofunctional monomers such as (meth) acrylonitrile; and bifunctional monomers such as divinylbenzene and alkylene glycol dimethacrylate. Here, “(meth) acrylate” means acrylate or methacrylate. Among these styrene-based resins, a copolymer of styrene or α-methylstyrene and (meth) acrylate (styrene-acrylic copolymer) is preferable.

The content of the styrene-based resin in the toner particle according to the present embodiment is preferably in a range from 5 times to 10 times the content of the ester wax functioning as the encapsulation accelerator, and more preferably in a range from 6 times to 8 times. When the content ratio is within the above range, the dispersibility of the styrene-based resin can be enhanced, and the heat-resistant storage capability and the fixability on the high temperature side of the fixable temperature range of the toner can be further enhanced.

In addition, the content of the styrene-based resin in the toner particle is preferably in a range from 3.5 mass % to 7 mass % and more preferably in a range from 4 mass % to 6 mass %.

The glass transition temperature of the styrene-based resin is preferably 70° C. or less and more preferably in a range from 50° C. to 70° C.

The SP value of the styrene-based resin is preferably in a range from 8.0 to 11.5 and more preferably in a range from 9.0 to 10.0.

### Hydrocarbon-Based Wax

The toner particles according to the present embodiment contain a hydrocarbon-based wax as a release agent. Since the ester wax is also added as the encapsulation accelerator to the toner particles according to the present embodiment like the toner particles T illustrated on the right side of FIG. 1, the ratio of “the hydrocarbon-based wax encapsulated in the styrene-based resin” to “the total amount of the hydrocarbon-based wax added to the toner particles” is high.

The hydrocarbon-based wax is a wax containing carbon atoms and hydrogen atoms, and examples thereof include polyethylene wax, polypropylene wax, paraffin wax, Fischer-Tropsch wax, and microcrystalline wax. Among these hydrocarbon-based waxes, paraffin wax is preferable. One of these waxes may be used individually, or two or more may be used in combination.

The content of the hydrocarbon-based wax in the toner particle according to the present embodiment is preferably in a range from 2 times to 5 times the content of the ester wax functioning as the encapsulation accelerator, and more preferably in a range from 2 times to 4 times. When the content ratio is within the range described above, the dispersibility of the hydrocarbon-based wax can be enhanced, and it is possible to further enhance the heat-resistant storage capability of the toner and to further suppress the burn-in of the toner on the developing roller.

In addition, the content of the hydrocarbon-based wax in the toner particle is preferably in a range from 1.5 mass % to 3.5 mass % and more preferably in a range from 2 mass % to 3 mass %.

The melting point of the hydrocarbon-based wax is preferably in a range from 60° C. to 100° C. and more preferably in a range from 60° C. to 80° C.

The SP value of the hydrocarbon-based wax is preferably in a range from 7.5 to 9.5 and more preferably in a range from 8.0 to 8.5.

### Ester Wax

The toner particles according to the present embodiment contain an ester wax as an encapsulation accelerator.

Here, the encapsulation accelerator refers to an agent that brings about an effect of bringing the hydrocarbon-based wax and the styrene-based resin together, and consequently brings about an effect of increasing the ratio of the hydrocarbon-based wax encapsulated in the dispersed particles of the styrene-based resin and an effect of enhancing the dispersibility of the styrene-based resin and the hydrocarbon-based wax. Since the ester wax can realize the effect of enhancing the dispersibility by itself, encapsulation accelerator in the present specification means the ester wax.

As the ester wax, for example, Nissan Electol WEP-5, WEP-14, WEP-15, WE-15 (all trade names) manufactured by NOF CORPORATION can be used.

The content of the ester wax in the toner particle according to the present embodiment is preferably in a range from 0.2 mass % to 1 mass % and more preferably in a range from 0.5 mass % to 0.9 mass %. When the content of the ester wax is within the range described above, the hydrocarbon-based wax is easily encapsulated in the styrene-based resin, and it is possible to further enhance the heat-resistant storage capability of the toner and to further suppress the burn-in of the toner on the developing roller.

The melting point of the ester wax is preferably in a range from 70° C. to 110° C. and more preferably in a range from 70° C. to 80° C.

The SP value of the ester wax is preferably in a range from 8.0 to 9.5 and more preferably in a range from 8.5 to 9.0.

### Colorant

The toner particles according to the present embodiment may contain a colorant. As the colorant, organic pigments, organic dyes, inorganic pigments, inorganic dyes, and the like used in the field of electrophotography can be used.

Examples of a black colorant include carbon black, copper oxide, manganese dioxide, aniline black, activated carbon, nonmagnetic ferrite, magnetic ferrite, and magnetite.

Examples of a yellow colorant include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C.I. Pigment Blue 15, C.I. Pigment Blue 15:2, C.I. Pigment Blue 15:3, C.I. Pigment Blue 16, and C.I. Pigment Blue 60.

The content of the colorant in the toner particles is preferably in a range from 3 parts by mass to 10 parts by mass. Note that to uniformly disperse the colorant in the binder resin, the colorant may be used in the form of masterbatch.

### Charge Control Agent

The toner particles according to the present embodiment may contain a charge control agent. The charge control agent is added to impart a preferable charging property to the toner. The charge control agent is not particularly limited, and charge control agents for positive charge control and negative charge control used in the field of electrophotography can be used.

Examples of a charge control agent for positive charge control include quaternary ammonium salts, pyrimidine compounds, triphenylmethane derivatives, guanidine salts, and amidine salts.

Examples of a charge control agent for negative charge control include metal-containing azo compounds, azo complex dyes, metal complexes and metal salts of salicylic acid and derivatives thereof (the metal is chromium, zinc, zirconium, or the like), organic bentonite compounds, and boron compounds.

These charge control agents may be used individually, or two or more may be used in combination. The content of the charge control agent in the toner particle is preferably in a range from 0.5 mass % to 5 mass %.

### 2. External Additive

In the toner according to the present embodiment, an external additive may be attached to the surface of the toner particle described above. Examples of the function of the external additive include a function of enhancing powder fluidity, triboelectric chargeability, heat-resistant storage capability, and cleaning characteristics of the toner, a function of controlling abrasion characteristics of the surface of the photoreceptor, and the like.

Examples of an external additive include inorganic microparticles such as silica, titanium oxide, and alumina having an average primary particle size in a range from 5 nm to 200 nm. Inorganic fine particles to which hydrophobicity is imparted by subjecting the surfaces of these inorganic fine particles to surface treatment with a silane coupling agent, a titanium coupling agent, or silicone oil are more preferable because the decrease in electric resistance and charge amount in a high-humidity environment is small.

The content of the external additive is preferably in a range from 0.1 parts by mass to 5 parts by mass and more preferably in a range from 0.2 parts by mass to 3 parts by mass relative to 100 parts by mass of the toner particle. When the content of the external additive is less than the lower limit, it is difficult to impart the effect of enhancing fluidity. When the content of the external additive exceeds the upper limit, there is a concern that fixability may decrease.

Examples of a method for adding the external additive to the toner particles include a method in which the toner particles and the external additive are mixed with an air flow mixer such as a Henschel mixer.

### EXAMPLES

Hereinafter, the toner of the disclosure will be specifically described on the basis of Examples and Comparative Examples. First, various measurement methods and evaluation methods will be described.

### 1. Measurement Method and Evaluation Method

### —Measurement Method of Average Dispersion Diameter and Encapsulation Ratio of Styrene-Based Resin and Hydrocarbon-Based Wax—

A cured product obtained by embedding the toner particles of Examples and Comparative Examples in an epoxy resin curable at room temperature was subjected to cutting with an ultramicrotome (manufactured by Reichert, trade name: Ultracut N) equipped with a diamond knife. The obtained cross section of the toner particle is observed with a scanning transmission electron microscope (available from Hitachi High-Technologies Corporation, model: S-4800). A considerable number (20 to 30) of dispersed particles of the styrene-based resins of 50 nm or more were randomly extracted from the electron microscope photo data, and image analysis was performed using image analysis software (trade name: A-ZO KUN, available from Asahi Kasei Engineering Corporation) to determine the average dispersion diameter of the styrene-based resins dispersed in the toner particles and the average dispersion diameter of the hydrocarbon-based wax encapsulated in the styrene-based resin (dispersed in the styrene-based resin).

The encapsulation ratio was calculated from the particle size of the dispersed particles of the styrene-based resin (the dispersion diameter of the styrene-based resin) and the average dispersion diameter of the hydrocarbon-based wax encapsulated in the dispersed particles of the styrene-based resin. In other words, the encapsulation ratio is the volume ratio of the hydrocarbon-based wax in the dispersed particles of the styrene-based resin. However, since it is calculated on the basis of the average dispersion diameter obtained from the electron microscope photo data as described above, it is an area ratio in terms of measurement.

Specifically, the dispersed particles of the styrene-based resin dispersed in the binder resin (main resin) of the toner particles were randomly selected, and the area calculated from the average dispersion diameter of the hydrocarbon-based wax dispersed therein was divided by the area calculated from the dispersion diameter of the randomly selected dispersed particles of the styrene-based resin to calculate the encapsulation ratio of the hydrocarbon-based wax in the dispersed particles. Furthermore, when 30 dispersed particles of the styrene-based resin were selected at random, the encapsulation ratio in each dispersed particle was calculated, and the average value thereof was defined as the encapsulation ratio in each of the Examples and Comparative Examples.

### SP Value Measurement Method

The SP value was measured in the following manner according to the method of Suh and Clarke (K. W. Suh, D. H. Clarke, “Cohesive Energy Densities of Polymers from Turbidimetric Titrations”, Journal of Polymer Science, A-1, vol. 5, 1967, p. 1671 to 1681).

0.5 g of the resin to be measured was weighed in a 100 mL beaker, 10 mL of a good solvent (mixed solution of dioxane and acetone) was added with a transfer pipette, and the resin was dissolved by stirring with a magnetic stirrer. A hydrophobic solvent (mixed solution of n-hexane and ion-exchanged water) was added dropwise with a 50 mL burette, and the point at which cloudiness occurred at a measurement temperature of 20° C. was taken as the drop amount.

From the measured values, the SP value δ of the resin was determined by the following Formula.

$$δ = ( V 1 / 2 δ l + Vh / 2 δ h ) / ( V 1 / 2 + Vh / 2 )$$

In the above formula, Vl is the molecular volume (mL/mol) of the solvent in the low SP solvent (hydrophobic solvent) mixed system, Vh is the molecular volume (mL/mol) of the solvent in the high SP solvent (good solvent) mixed system, δl is the SP value of the solvent in the low SP solvent (hydrophobic solvent) mixed system, and δh is the SP value of the solvent in the high SP solvent (good solvent) mixed system.

### —Fixability Evaluation Method (Evaluation on High Temperature Side of Fixable Temperature Range)—

A fixed image was formed with a two-component developer using a commercially available copy machine (available from Sharp Corporation, model: MX-5100FN) modified for evaluation. First, a sample image including a solid image (a rectangle 20 mm long and 50 mm wide) was formed as an unfixed image on a recording sheet (PPC sheet available from Sharp Corporation, model: SF-4AM3). At this time, the amount of the toner adhering to the recording sheet in the solid image was adjusted to 1.0 mg/cm².

Next, a fixed image was prepared using a belt fixing device. The fixing process speed was set to 283 mm/sec, and the temperature of the fixing belt was raised from 110° C. in increments of 5° C. to determine the lowest temperature at which hot offset did not occur. “Hot offset” means that the toner is not fixed to the recording paper at the time of fixing but remains attached to the fixing belt, and is attached to the recording paper after the fixing belt makes one round.

“Fixability” was evaluated as follows on the basis of the measured lowest temperature.
⊙ (Excellent): The lowest temperature is 195° C. or higher
◯ (Good): The lowest temperature is 185° C. or higher and less than 195° C.
Δ (Marginal): The lowest temperature is 175° C. or higher and less than 185° C.
x (Poor): The lowest temperature is less than 175° C.

### —Heat-Resistant Storage Capability Evaluation Method—

Heat-resistant storage capability was evaluated on the basis of the presence or absence of aggregates after high-temperature storage. 20 g of the toner (toner after the external addition step) was sealed in a polycontainer and left at 50° C. for 72 hours, and then the toner was taken out and sieved through a 230 mesh sieve. The weight of the toner remaining on the sieve was measured, and the remaining amount, which is the ratio with respect to the total weight of the toner, was obtained.

“Heat-resistant storage capability” was evaluated according to the following criteria on the basis of the measured residual amount.
⊙ (Excellent): No aggregation The residual amount is less than 0.5%
◯ (Good): Slight amount of aggregation The residual amount is 0.5% or more and less than 7%
Δ (Marginal): Large amount of aggregation The residual amount is 7% or more and less than 12%
x (Poor): Large amount of aggregation The residual amount is 12% or more

### Burn-In On Developing Roller Phenomenon Evaluation Method

A development device and a toner cartridge of a color multi-function peripheral (available from Sharp Corporation, model: MX-2640) were filled with the prepared two-component developer and toner, respectively, and a continuous printing test of 50000 sheets was performed under an environment of 30° C. and 80% humidity so a square solid image (ID=1.45 to 1.50) with sides of 1 cm is formed at three positions, a central portion and both end portions, in the axial direction of the developing roller.

On the basis of this continuous printing test, the burn-in phenomenon was evaluated according to the following criteria.
⊙ (Excellent): There is no decrease in density from the initial image to the fifty thousandth image, and there is no fusing of the toner on the developing roller surface
◯ (Good): There is no decrease in density from the initial image to the fifty thousandth image, but slight fusing of the toner on the surface of the developing roller is observed
Δ (Marginal): There is no decrease in density from the initial image to the fifty thousandth image, but there is fusing of the toner on the surface of the developing roller
x (Poor): There is a decrease in density from the initial image to the fifty thousandth image, and there is fusing of the toner on the surface of the developing roller.

### 2. Method for Producing Toner

First, physical properties of a styrene-based resin, a hydrocarbon-based wax, and an ester wax as an encapsulation accelerator used in Examples and Comparative Examples are listed in Tables 1 to 3 below.

TABLE 1

| Sample name of styrene-based resin | SP value (SP1) |
|---|---|
| A | 9.5 |
| B | 8.1 |
| C | 10.2 |

TABLE 2

| Sample name of | Melting point | SP value |
|---|---|---|
| hydrocarbon-based wax | (T1) (° C.) | (SP2) |
| A | 75 | 8.1 |
| B | 71 | 9.0 |
| C | 90 | 8.5 |
| D (ester wax of | 79 | 8.6 |
| Comparative Example 6) | | |

TABLE 3

| Sample name of encapsulation | Melting point | SP value |
|---|---|---|
| accelerator (ester wax) | (T2) (° C.) | (SP3) |
| A | 76 | 8.9 |
| B | 76 | 9.3 |

### Example 1

### Toner Particle Preparation Step

The following toner materials were used to prepare toner particles (toner cores).

### Resin

Binder resin: amorphous polyester-based resin, 84.8 mass %
Styrene-based resin A, 5 mass %

### Colorant

Carbon black (trade name: Regal 330, available from Cabot Corporation), 6 mass %

### Release Agent

Hydrocarbon-based wax A (trade name: HNP10, available from NIPPON SEIRO CO., LTD.), 2.5 mass %

### Encapsulation Accelerator

Ester wax A (trade name: WE-15, available from the NOF Corporation), 0.7 mass %

### Charge Control Agent

Boron compound (trade name: LR-147, available from Japan Carlit Co., Ltd.), 1 mass %

The materials described above were pre-mixed for 5 minutes using a Henschel mixer (available from NIPPON COKE & ENGINEERING CO., LTD., model: FM20C), and then melt-kneaded using a twin-screw extruder at a cylinder setting temperature of 110° C., a barrel rotation speed of 300 rpm, and a material feeding rate of 20 kg/hour to obtain a melt-kneaded product.

The obtained melt-kneaded product was cooled using a cooling belt, coarsely pulverized by a cutting mill, finely pulverized by a jet pulverizer, and classified by an air classifier to obtain toner particles having an average particle size of 6.7 μm.

### External Addition

1.0 parts by mass of silica particles (trade name: R976, available from Nippon Aerosil Co., Ltd., average primary particle size: 7 nm) was added to 100 parts by mass of the obtained toner particles, and the mixture was stirred for 2 minutes using a Henschel mixer (available from NIPPON COKE & ENGINEERING CO., LTD., model: FM20C) in which the tip speed of the stirring blade was set to 40 m/sec to obtain a toner of Example 1.

### Two-Component Developer Preparation Step

The toner obtained in the external addition step and a resin-coated carrier were mixed so that the concentration of the toner was 7 mass % with respect to the total amount of the two-component developer to obtain a two-component developer having a toner concentration of 7 mass %.

### Examples 2 to 24 and Comparative Examples 1 to 7

A toner and a two-component developer were obtained in a similar manner as in Example 1 except that the types (physical properties), added amounts, and average dispersion diameters of the “styrene-based resin”, the “hydrocarbon-based wax”, and the “ester wax as an encapsulation accelerator” used were changed as list in Table 4 below.

TABLE 4

| | | | | | Average | Average | | |
|---|---|---|---|---|---|---|---|---|
| | Presence/ | Added | | | dispersion | dispersion | | |
| | absence of | styrene- | Added | Added | diameter of | diameter of | | |
| | encapsulation | based | hydrocarbon- | encapsulation | styrene-based | hydrocarbon- | | Encapsulation |
| | accelerator | resin | based wax | accelerator | resin | based wax | | ratio |
| Example 1 | Present | A | A | A | 600 nm | 100 | nm | 30% |
| Example 2 | Present | A | A | A | 200 nm | 100 | nm | 30% |
| Example 3 | Present | A | A | A | 900 nm | 100 | nm | 30% |
| Example 4 | Present | A | A | A | 600 nm | 50 | nm | 30% |
| Example 5 | Present | A | A | A | 600 nm | 300 | nm | 30% |
| Example 6 | Present | A | A | A | 600 nm | 100 | nm | 20% |
| Example 7 | Present | A | A | A | 400 nm | 100 | nm | 50% |
| Example 8 | Present | A | B | A | 600 nm | 100 | nm | 30% |
| Example 9 | Present | B | A | A | 400 nm | 100 | nm | 30% |
| Example 10 | Present | A | A | B | 400 nm | 100 | nm | 30% |
| Example 11 | Present | C | A | A | 600 nm | 100 | nm | 30% |
| Example 12 | Present | A | C | A | 600 nm | 100 | nm | 30% |
| Example 13 | Present | A | A | A | 600 nm | 110 | nm | 25% |
| Example 14 | Present | A | A | A | 500 nm | 80 | nm | 35% |
| Example 15 | Present | A | A | A | 700 nm | 120 | nm | 25% |
| Example 16 | Present | A | A | A | 400 nm | 70 | nm | 40% |
| Example 17 | Present | A | A | A | 600 nm | 90 | nm | 25% |
| Example 18 | Present | A | A | A | 600 nm | 120 | nm | 35% |
| Example 19 | Present | A | A | A | 600 nm | 80 | nm | 22% |
| Example 20 | Present | A | A | A | 600 nm | 150 | nm | 40% |
| Example 21 | Present | A | A | A | 500 nm | 100 | nm | 40% |
| Example 22 | Present | A | A | A | 700 nm | 100 | nm | 35% |
| Example 23 | Present | A | A | A | 400 nm | 100 | nm | 45% |
| Example 24 | Present | A | A | A | 800 nm | 100 | nm | 25% |
| Comparative | Absent | A | A | — | 400 nm | 150 | nm | 30% |
| Example 1 | | | | | | | | |
| Comparative | Present | A | A | A | 1000 nm | 100 | nm | 30% |
| Example 2 | | | | | | | | |
| Comparative | Present | A | A | A | 100 nm | 50 | nm | 40% |
| Example 3 | | | | | | | | |
| Comparative | Present | A | A | A | 600 nm | 500 | nm | 30% |
| Example 4 | | | | | | | | |
| Comparative | Present | A | A | A | 600 nm | 40 | nm | 30% |
| Example 5 | | | | | | | | |
| Comparative | Present | A | D | A | 500 nm | 75 nm | | 60% |
| Example 6 | | | (ester wax) | | | (ester wax) | | |
| Comparative | Present | A | A | A | 600 nm | 100 | nm | 10% |

Example 7

| | | | | | | Added | |
|---|---|---|---|---|---|---|---|
| | | | | | | amount ratio | Added amount |
| | | | | Size | Added | (hydrocarbon- | ratio (styrene- |
| | | | | relationship | amount of | based wax/ | based resin/ |
| | | | | between T1 | encapsulation | encapsulation | encapsulation |
| | SP1 | SP2 | SP3 | and T2 | accelerator | accelerator) | accelerator) |
| Example 1 | 9.5 | 8.1 | 8.9 | T1 < T2 | 0.70% | 3 | 7 |
| Example 2 | 9.5 | 8. | 8.9 | T1 < T2 | 0.70% | 3 | 7 |
| Example 3 | 9.5 | 8.1 | 8.9 | T1 < T2 | 0.70% | 3 | 7 |
| Example 4 | 9.5 | 8.1 | 8.9 | T1 < T2 | 0.70% | 3 | 7 |
| Example 5 | 9.5 | 8.1 | 8.9 | T1 < T2 | 0.70% | 3 | 7 |
| Example 6 | 9.5 | 8.1 | 8.9 | T1 < T2 | 0.70% | 3 | 7 |
| Example 7 | 9.5 | 8.1 | 8.9 | T1 < T2 | 0.70% | 3 | 7 |
| Example 8 | 9.5 | 8.1 | 8.9 | T1 < T2 | 0.70% | 3 | 7 |
| Example 9 | 8.1 | 8.1 | 8.9 | T1 < T2 | 0.70% | 3 | 7 |
| Example 10 | 9.5 | 8.1 | 9.3 | T1 < T2 | 0.70% | 3 | 7 |
| Example 11 | 10.2 | 8.1 | 8.9 | T1 < T2 | 0.70% | 3 | 7 |
| Example 12 | 9.5 | 8.5 | 8.9 | T1 > T2 | 0.70% | 3 | 7 |
| Example 13 | 9.5 | 8.1 | 8.9 | T1 < T2 | 0.20% | 3 | 7 |
| Example 14 | 9.5 | 8.1 | 8.9 | T1 < T2 | 1.00% | 3 | 7 |
| Example 15 | 9.5 | 8.1 | 8.9 | T1 < T2 | 0.10% | 3 | 7 |
| Example 16 | 9.5 | 8. | 8.9 | T1 < T2 | 2.00% | 3 | 7 |
| Example 17 | 9.5 | 8.1 | 8.9 | T1 < T2 | 0.70% | 2 | 7 |
| Example 18 | 9.5 | 8.1 | 8.9 | T1 < T2 | 0.70% | 5 | 7 |
| Example 19 | 9.5 | 8.1 | 8.9 | T1 < T2 | 0.70% | 1 | 7 |
| Example 20 | 9.5 | 8.1 | 8.9 | T1 < T2 | 0.70% | 10 | 7 |
| Example 21 | 9.5 | 8.1 | 8.9 | T1 < T2 | 0.70% | 3 | 5 |
| Example 22 | 9.5 | 8.1 | 8.9 | T1 < T2 | 0.70% | 3 | 10 |
| Example 23 | 9.5 | 8.1 | 8.9 | T1 < T2 | 0.70% | 3 | 2 |
| Example 24 | 9.5 | 8.1 | 8.9 | T1 < T2 | 0.70% | 3 | 20 |
| Comparative | 9.5 | 8.1 | — | — | — | — | — |
| Example 1 | | | | | | | |
| Comparative | 9.5 | 8.1 | 8.9 | T1 < T2 | 0.70% | 3 | 7 |
| Example 2 | | | | | | | |
| Comparative | 9.5 | 8.1 | 8.9 | T1 < T2 | 0.70% | 3 | 7 |
| Example 3 | | | | | | | |
| Comparative | 9.5 | 8.1 | 8.9 | T1 < T2 | 0.70% | 3 | 7 |
| Example 4 | | | | | | | |
| Comparative | 9.5 | 8.1 | 8.9 | T1 < T2 | 0.70% | 3 | 7 |
| Example 5 | | | | | | | |
| Comparative | 9.5 | 8.6 | 8.9 | T1 < T2 | 0.70% | 3 | 7 |
| Example 6 | | | | | | | |
| Comparative | 9.5 | 8.1 | 8.9 | T1 < T2 | 0.60% | 2 | 6 |
| Example 7 | | | | | | | |

TABLE 5

| | Fixability | Heat- | |
|---|---|---|---|
| | (high temperature | resistant | |
| | side of fixable | storage | Burn-in |
| | temperature range) | capability | phenomenon |
| Example 1 | Excellent | Excellent | Excellent |
| Example 2 | Excellent | Good | Good |
| Example 3 | Marginal | Excellent | Excellent |
| Example 4 | Marginal | Excellent | Excellent |
| Example 5 | Good | Marginal | Marginal |
| Example 6 | Good | Marginal | Marginal |
| Example 7 | Marginal | Good | Good |
| Example 8 | Good | Good | Good |
| Example 9 | Good | Good | Good |
| Example 10 | Good | Marginal | Marginal |
| Example 11 | Good | Marginal | Marginal |
| Example 12 | Good | Marginal | Good |
| Example 13 | Good | Marginal | Marginal |
| Example 14 | Good | Marginal | Good |
| Example 15 | Good | Marginal | Marginal |
| Example 16 | Good | Marginal | Marginal |
| Example 17 | Good | Excellent | Excellent |
| Example 18 | Excellent | Good | Marginal |
| Example 19 | Marginal | Excellent | Excellent |
| Example 20 | Excellent | Marginal | Marginal |
| Example 21 | Excellent | Good | Good |
| Example 22 | Good | Excellent | Excellent |
| Example 23 | Excellent | Marginal | Marginal |
| Example 24 | Marginal | Excellent | Excellent |
| Comparative | Good | Marginal | Poor |
| Example 1 | | | |
| Comparative | Poor | Good | Good |
| Example 2 | | | |
| Comparative | Good | Poor | Marginal |
| Example 3 | | | |
| Comparative | Marginal | Marginal | Poor |
| Example 4 | | | |
| Comparative | Poor | Good | Good |
| Example 5 | | | |
| Comparative | Poor | Marginal | Marginal |
| Example 6 | | | |
| Comparative | Good | Poor | Poor |
| Example 7 | | | |

Table 5 shows the evaluation results of Examples and Comparative Examples. In Examples 1 to 24, the toner particles contain a styrene-based resin dispersed in a binder resin, a hydrocarbon-based wax dispersed in the styrene-based resin, and an ester wax as an encapsulation accelerator. The average dispersion diameter of the styrene-based resin is in a range from 200 nm to 900 nm, the average dispersion diameter of the hydrocarbon-based wax is less than the average dispersion diameter of the styrene-based resin and is in a range from 50 nm to 300 nm, and the encapsulation ratio, which is the volume ratio of the hydrocarbon-based wax in the dispersed particles of the styrene-based resin, is in a range from 20% to 50%. As is clear from the evaluation results in Table 5, Examples 1 to 24 satisfying these requirements were able to suppress burn-in on the developing roller while achieving both fixability and heat-resistant storage capability for a low-temperature fixable toner.

On the other hand, in Comparative Examples 1 to 7 which do not satisfy these requirements, the evaluation results of the fixability, the heat-resistant storage capability, and the burn-in phenomenon on the developing roller were inferior to those of Examples.

When the SP value of the styrene-based resin is SP1, the SP value of the hydrocarbon-based wax is SP2, and the SP value of the encapsulation accelerator (ester wax) is SP3, it can be seen that Example 1 and the like satisfying the relationship SP2<SP3<SP1 are more highly evaluated in the various items than Example 8 which satisfies the relationship SP3<SP2<SP1 and Example 9 which satisfies the relationship of the equation of SP1=SP2 <SP3.

It can be seen that Example 1 and the like satisfying the relationships of the following Formulas (1) and (2) particularly achieve an excellent in the evaluation of the heat-resistant storage capability and the burn-in phenomenon on the developing roller as compared with Example 10 in which SP3−SP2 exceeds 1.0 and does not satisfy the relationship of the following Formula (1) and Example 11 in which SP1−SP3 exceeds 1.0 and does not satisfy the relationship of the following Formula (2).

$$SP 3 - SP 2 \leq 1. \qquad ( 1 )$$

$$SP 1 - SP 3 \leq 1. . \qquad ( 2 )$$

When the melting point of the hydrocarbon-based wax is Tl and the melting point of the encapsulation accelerator (ester wax) is T2, it can be seen that Example 1 and the like satisfying the relationship T1<T2 particularly achieve an excellent in the evaluation of the heat-resistant storage capability as compared with Example 12 which does not satisfy this relationship.

It can be seen that Example 1, 13, 14 and the like in which the content of the encapsulation accelerator (ester wax) in the toner particles is in a range from 0.2 mass % to 1 mass % particularly achieve excellent in the evaluation of the burn-in phenomenon on the developing roller as compared with Example 15 and 16 in which the content is outside of the range described above.

It can be seen that Example 1, 17, 18 and the like in which the content of the hydrocarbon-based wax in the toner particles is in a range from 2 times to 5 times the content of the encapsulation accelerator (ester wax) particularly achieve excellent in the evaluation of the fixability (hot offset) as compared with Example 19 in which the content ratio is less than the lower limit described above and particularly achieve excellent in the evaluation of the heat-resistant storage capability and the burn-in phenomenon on the developing roller as compared with Example 20 in which the content ratio exceeds the upper limit described above.

It can be seen that Example 21 and 22 in which the content of the styrene-based resin in the toner particles is in a range from 5 times to 10 times the content of the encapsulation accelerator (ester wax) particularly achieve excellent in the evaluation of the heat-resistant storage capability and the burn-in phenomenon on the developing roller as compared with Example 23 in which the content ratio is less than the lower limit described above and particularly achieves excellent in the evaluation of the fixability (hot offset) as compared with Example 24 in which the content ratio exceeds the upper limit described above.

The embodiments disclosed herein are illustrative in all respects and are not the basis for a limited interpretation. Accordingly, the technical scope of the disclosure is not to be construed by the foregoing embodiments only, and is defined based on the description of the claims. In addition, meanings equivalent to the range of the claims and all changes made within the range are included.

### REFERENCE SIGNS LIST

1 Binder resin
2 Hydrocarbon-based wax
3 Styrene-based resin
4 Encapsulation accelerator (ester wax)
T Toner particle

1. A toner comprising:
a toner particle including a binder resin, wherein
the toner particle includes a styrene-based resin dispersed in the binder resin, a hydrocarbon-based wax dispersed in the styrene-based resin, and an ester wax as an encapsulation accelerator,
the styrene-based resin has an average dispersion diameter in a range from 200 nm to 900 nm,
the hydrocarbon-based wax has an average dispersion diameter that is less than the average dispersion diameter of the styrene-based resin and is in a range from 50 nm to 300 nm, and
an encapsulation ratio, which is a volume ratio of the hydrocarbon-based wax in dispersed particles of the styrene-based resin, is in a range from 20% to 50%.

2. The toner according to claim 1, wherein
when an SP value of the styrene-based resin is SP1, an SP value of the hydrocarbon-based wax is SP2, and an SP value of the ester wax is SP3, a relationship of SP2<SP3<SP1 is satisfied.

3. The toner according to claim 2, wherein
formulas (1) and (2) are satisfied:
$$SP 3 - SP 2 \leq 1. \qquad ( 1 )$$
$$SP 1 - SP 3 \leq 1. . \qquad ( 2 )$$

4. The toner according to claim 1, wherein
when a melting point of the hydrocarbon-based wax is T1 and a melting point of the ester wax is T2, a relationship of T1<T2 is satisfied.

5. The toner according to claim 1, wherein
a content of the ester wax in the toner particle is in a range from 0.2 mass % to 1 mass %.

6. The toner according to claim 1, wherein
a content of the hydrocarbon-based wax in the toner particle is in a range from 2 times to 5 times a content of the ester wax.

7. The toner according to claim 1, wherein
a content of the styrene-based resin in the toner particle is in a range from 5 times to 10 times a content of the ester wax.
